(19) United States
(12) Patent Application Publication
(10) Pub. No.: US 2023/0182499 A1
(43) Pub. Date: Jun. 15, 2023

(54) SYSTEM AND METHOD FOR AUTOMATED INSCRIPTION

(71) Applicant: Audience.co, Inc., Coral Gables, FL (US)

(72) Inventor: Jesse Stein, Key Biscayne, FL (US)

(21) Appl. No.: 18/082,391

(22) Filed: Dec. 15, 2022

Related U.S. Application Data
(60) Provisional application No. 63/289,750, filed on Dec. 15, 2021.

(51) Int. Cl. B43L 13/02; B43K 29/08

(52) U.S. Cl. CPC B43L 13/024; B43K 29/08

(57) ABSTRACT

Systems and methods are disclosed directed toward the inscription of handwritten notes. The embodiments of the present disclosure enable autonomous or semi-autonomous drafting of words, symbols, letters, or signs on sheets of paper or other material using a pen plotter mechanically coupled with a writing instrument.

### CROSS REFERENCE TO RELATED APPLICATION

The present application claims priority to U.S. Provisional Application No. 63/289,750, filed Dec. 15, 2021, the entire disclosure of which is hereby incorporated by reference.

### BACKGROUND

The present disclosure is generally directed to inscription machines and relates more particularly to automated writing systems.

Conventional commercial printing systems and machines are capable of generating correspondence that can be mailed in mass quantities. These commercial printing systems utilize standard computer typefaces, or machine typeset, that produces repeatable and invariable output.

### BRIEF SUMMARY

Although conventional commercial printing and mailing systems offer a scalable way to communicate with large numbers of people, the computer typefaces lack a personal touch and are largely ignored by recipients. Even script-based computer typefaces suffer from a personal handwritten appearance in that there is no true cursive interaction between characters. Moreover, the characters used in typefaces are consistent in size, shape, and output. While images of handwritten text may be printed to a page, there is no true ink-on-page appearance and the practice does not scale to allow changes to the text used from one letter to another.

It is with respect to the above issues and other problems that the embodiments presented herein were contemplated. Traditional handwritten mail has remained an effective way to build genuine relationships between people, but the practice has grown out of favor due to a lack of scalability and, more specifically, the time and resources required to generate personal letters in mass. The personalized automatic handwritten notes provided by the methods and systems described herein generate automatic machine-handwritten inscriptions that are capable of enhancing relationships and that are more likely to be read by a recipient.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE SEVERAL VIEWS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a schematic block diagram of an automated plotting system according to at least one embodiment of the present disclosure;

FIG. 2A is a perspective detail view of a plotting station of the automated plotting system according to at least one embodiment of the present disclosure;

FIG. 2B is a side elevation view of the plotting station of FIG. 2A;

FIG. 3A is a perspective view of multiple plotting stations of the automated plotting system according to at least one embodiment of the present disclosure;

FIG. 3B is a front elevation view of the multiple plotting stations of the automated plotting system according to at least one embodiment of the present disclosure;

FIG. 3C is a plan view of the multiple plotting stations of the automated plotting system according to at least one embodiment of the present disclosure;

FIG. 4A is a perspective view of an automated plotting system according to at least one embodiment of the present disclosure;

FIG. 4B is a front elevation view of the automated plotting system of FIG. 4A;

FIG. 4C is a side elevation view of the automated plotting system of FIG. 4A;

FIG. 4D is a plan view of the automated plotting system of FIG. 4A;

FIG. 5 is a flow diagram of a method for generating an automated custom inscription according to at least one embodiment of the present disclosure; and

FIG. 6 is a flow diagram of a method for receiving an inscription order and generating an automated custom inscription according to at least one embodiment of the present disclosure.

### DETAILED DESCRIPTION

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

In one or more examples, the described methods, processes, and techniques may be implemented in hardware, software, firmware, or any combination thereof If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), graphics processing units (e.g., Nvidia GeForce RTX 2000-series processors, Nvidia GeForce RTX 3000-series processors, AMD Radeon RX 5000-series processors, AMD Radeon RX 6000-series processors, or any other graphics processing units), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

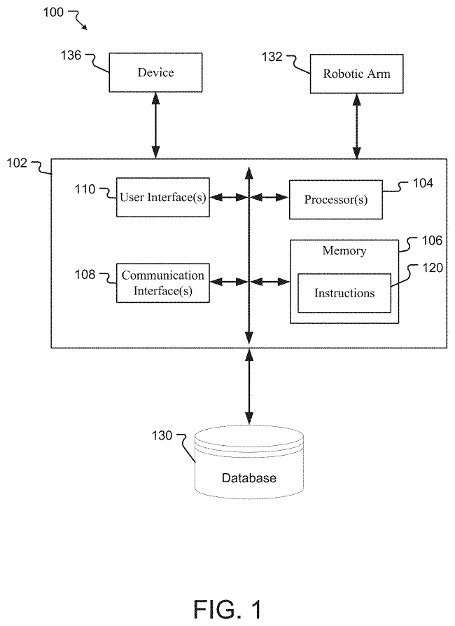

Turning first to FIG. 1, a block diagram of an automated plotting system 100 is shown according to at least one embodiment of the present disclosure. The automated plotting system 100 may be used to inscribe words and/or letters on a document, article, or other paper; to receive instructions for the inscription of words on paper and convert the same into one or more movements of a Axidraw pen plotter 132; and/or carry out one or more other aspects of one or more of the methods disclosed herein. The automated plotting system 100 comprises a computing device 102, a database 130, a Axidraw pen plotter 132, and/or a communication device 136. Systems according to other embodiments of the present disclosure may comprise more or fewer components than the automated plotting system 100. For example, the automated plotting system 100 may not include the communication device 136, and/or one or more components of the computing device 102 (e.g., a communication interface 108).

The computing device 102 comprises a processor 104, a memory 106, a communication interface 108, and a user interface 110. Computing devices according to other embodiments of the present disclosure may comprise more or fewer components than the computing device 102 shown in FIG. 1.

The processor 104 of the computing device 102 may be any processor described herein or any similar processor. The processor 104 may be configured to execute instructions 120 stored in the memory 106. The instructions 120 may cause the processor 104 to carry out one or more computing steps utilizing, or based on, data received from one or more of the database 130, the Axidraw pen plotter 132, and/or the communication device 136.

The memory 106 may be, or comprise, RAM, DRAM, SDRAM, other solid-state memory, any memory described herein, or any other tangible, non-transitory memory for storing computer-readable data and/or instructions. The memory 106 may store information or data useful for completing, for example, any step of the method 500 described herein, or of any other methods. The memory 106 may store, for example, instructions 120 that support one or more functions of the Axidraw pen plotter 132. For instance, the memory 106 may store instructions 120 that, when executed by the processor 104, enable or otherwise cause the Axidraw pen plotter 132 to move, such as instructions that cause the Axidraw pen plotter 132 to move such that one or more words or letters are inscribed on a document. In some embodiments, the instructions or other content of the memory 106 (e.g., other software) be organized into one or more applications, modules, packages, layers, or engines.

The computing device 102 may also comprise a communication interface 108. The communication interface 108 may be used for receiving data, instructions, or other information from an external source (such as the database 130, the Axidraw pen plotter 132, the device 136, and/or any other system or component not part of the system 100), and/or for transmitting instructions or other information to an external system or device (e.g., another computing device 102 and/or any other system or component not part of the system 100). The communication interface 108 may comprise one or more wired interfaces (e.g., a USB port, an Ethernet port, a Firewire port) and/or one or more wireless transceivers or interfaces (configured, for example, to transmit and/or receive information via one or more wireless communication protocols such as 802.11a/b/g/n, Bluetooth, NFC, ZigBee, and so forth). In some embodiments, the communication interface 108 may be useful for enabling the computing device 102 to communicate with one or more other processors 104 or computing devices 102, whether to reduce the time needed to accomplish a computing-intensive task or for any other reason.

The computing device 102 may also comprise one or more user interfaces 110. The user interface 110 may be, or comprise, a keyboard, mouse, trackball, monitor, television, screen, touchscreen, and/or any other device for receiving information from a user and/or for providing information to a user. The user interface 110 may be used, for example, to receive a user selection or other user input regarding any step of any method described herein. Notwithstanding the foregoing, any required input for any step of any method described herein may be generated automatically by the automated plotting system 100 (e.g., by the processor 104 or another component of the system 100) or received by the automated plotting system 100 from a source external to the system 100. Although the user interface 110 is shown as part of the computing device 102, in some embodiments, the computing device 102 may utilize a user interface 110 that is housed separately from one or more remaining components of the computing device 102. In some embodiments, the user interface 110 may be a component of the communication device 136, such as when the communication device 136 is a mobile device (e.g., smartphone, tablet, laptop, personal computer, etc.) or other device used by the user to send instructions to the Axidraw pen plotter 132. As an example, the user may wish to have a document written in cursive by the Axidraw pen plotter 132, and may send such instructions to the Axidraw pen plotter 132 via the user interface 110 of the communication device 136.

In some embodiments, the user interface 110 may be located proximate one or more other components of the computing device 102, while in other embodiments, the user interface 110 may be located remotely from one or more other components of the computer device 102.

The Axidraw pen plotter 132 may have, for example, one, two, three, or more degrees of freedom. The Axidraw pen plotter 132 may comprise one or more sensors that enable the processor 104 (or a processor of the Axidraw pen plotter 132) to determine a precise position and/or orientation in space of the Axidraw pen plotter 132 (as well as any object or element held by or secured to the Axidraw pen plotter 132). In some embodiments, such determinations may be made relative to a coordinate system or other component of the system 100 (such as a plane or plotting surface upon which a paper to be inscribed rests). In one example, the Axidraw pen plotter 132 may correspond to a cartesian coordinate robot configured to move an end effector along an X-axis, a Y-axis, and/or a Z-axis. A writing instrument, such as a pen or pencil, may be held by the end effector of the Axidraw pen plotter 132.

The database 130 may store information related to the operation of the Axidraw pen plotter 132, instructions to be processed by the processor 104 to cause the Axidraw pen plotter 132 to perform one or more movements, templates to be processed by the processor 104 for generating one or more inscriptions on a page or paper, and/or any other useful information. The database 130 may be configured to provide any such information to the computing device 102 or to any other device of the system 100 or external to the system 100.

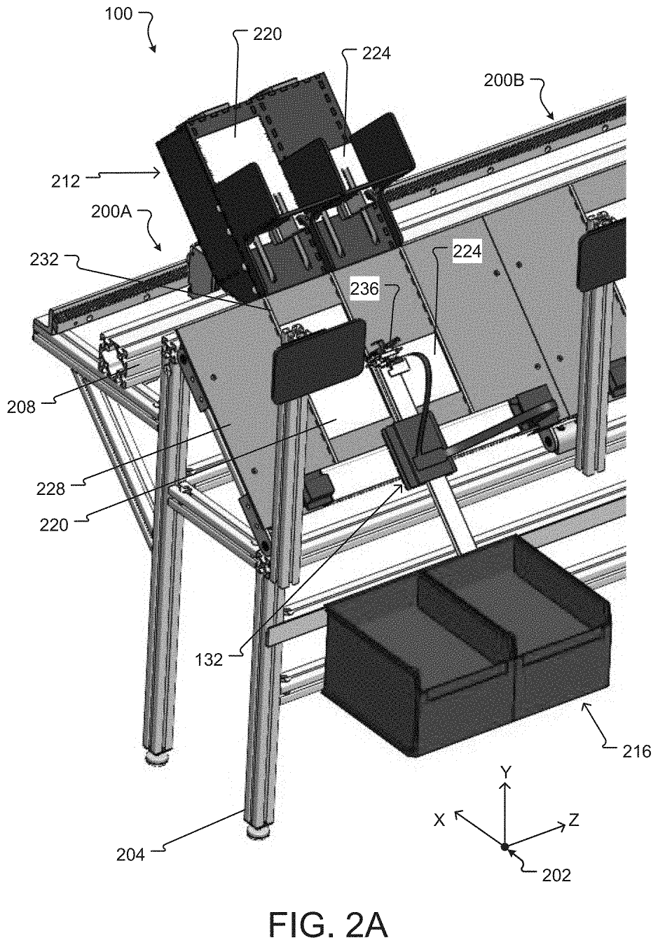

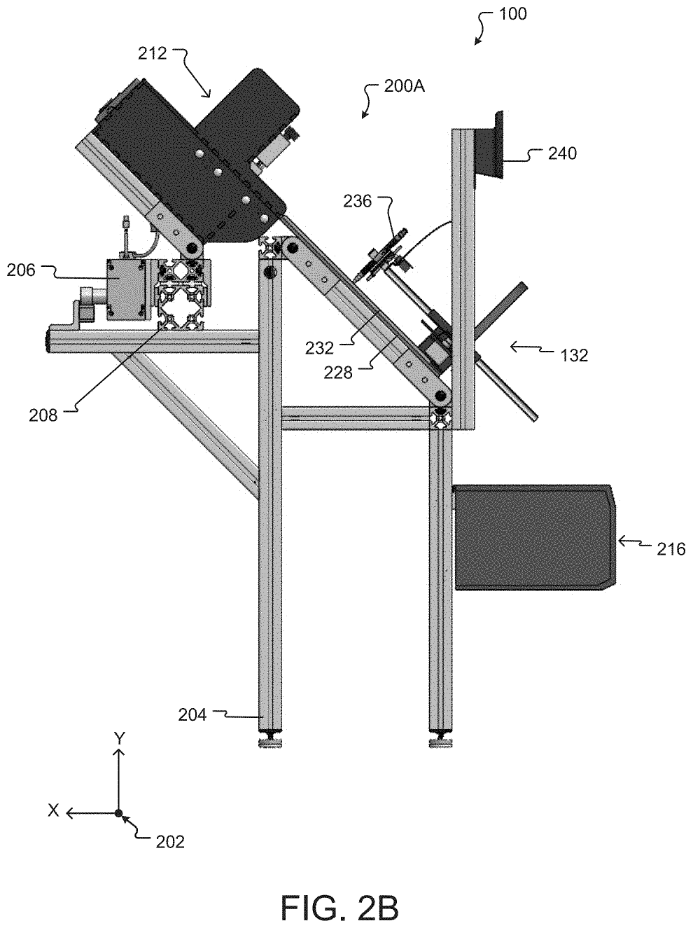

As provided herein, reference may be made to the coordinate system 202 in defining a position, arrangement, and/or size of components making up the system 100. As shown in FIGS. 2A-2B, a width, or depth, of the automated plotting system 100 runs along the X-axis of the coordinate system 202, a longitudinal length of the automated plotting system 100 may be defined by a measurement taken along the Z-axis of the coordinate system 202, and a height of the system 100 may be defined by a measurement taken along the Y-axis of the coordinate system 202. In addition to the various axes of the coordinate system 202, planes associated with the components of the system 100 may be defined by the various planes (e.g., the XY-plane, XZ-plane, and the YZ-plane) of the coordinate system 202.

FIGS. 2A-2B illustrate aspects of the automated plotting system 100, including a plotting station 200A and a portion of an adjacent plotting station 200B. The automated plotting system 100 comprises a frame 204, a linear guide rail 208, and a note and envelope feeder 212. The frame 204 may support one or more components of the system 100. The frame 204 may correspond to a machine frame (e.g., welded metal frame, extruded aluminum modular framing system, and/or other mechanical support frame, etc.). The linear guide rail 208 may be designed to mechanically couple with the note and envelope feeder 212, such that the note and envelope feeder 212 may move or slide in a first direction (e.g., a Z-axis direction of the coordinate system 202), while remaining fixed in one or more other directions (e.g., an X-axis direction, a Y-axis direction). In one example, the linear guide rail 208 may comprise at least one static support rail (e.g., extruded aluminum rail, rectangular tubing, etc.), a carriage, a linear drive unit 206, and a rack. The carriage may support the note and envelope feeder 212. In some examples, the carriage may move along the static support rail (e.g., along the Z-axis direction) via actuation of the linear drive unit 206 rotating a gear, or drive wheel, in contact with the rack (shown at the rear of the plotting station 200A and automated plotting system 100. The rack may span along a portion of the automated plotting system 100 and/or along an entire length of the automated plotting system 100. The rack may correspond to a geared rack that mates with the gear. The note and envelope feeder 212 may be configured to dispense a note 220 and/or an envelope 224 onto respective plotting surfaces 228 of the plotting station 200A and/or any other plotting station (e.g., plotting stations 200B-200I shown in FIG. 2C, etc.) of the automated plotting system 100. For example, the note and envelope feeder 212 and carriage may move along the static support rail as the linear drive unit 206 turns the drive wheel, or gear, along the rack. In this manner, a single note and envelope feeder 212 may dispense paper at multiple station locations of the automated plotting system 100. In some embodiments, the movement of the note and envelope feeder 212 may be partially or wholly controlled by a computing device 102 or component thereof (e.g., a processor 104) based on, for example, instructions 120 processed by the computing device 102. In one embodiment, the note and envelope feeder 212 may be caused to move to a first edge of the plotting surface 228 and dispense the note 220 and/or the envelope 224. The note and envelope feeder 212 may move along the first direction from the plotting station 200A to the plotting station 200B and repeat the dispensing process.

In some embodiments, the automated plotting system 100 may include one or more sensors that monitor the plotting surface 228 and, when there is no page on the plotting surface 228, generate a signal that causes the note and envelope feeder 212 to move to the first edge of the plotting surface 228 to dispense a page (e.g., the note 220, the envelope 224). In some embodiments, the note and envelope feeder 212 may be controlled by a linear drive unit 206. The linear drive unit 206 may be or comprise a motor (e.g., brushless DC motor, AC motor, pneumatic motor, etc.) and may cause the note and envelope feeder 212 to move along the linear guide rail 208. The linear drive unit 206 may be in communication with the computing device 102 or component thereof and may be operated based on signals or other control commands provided by the computing device 102. In some embodiments, the linear drive unit 206 may, in conjunction with one or more sensors, be controlled using feedback loops, such that the note and envelope feeder 212 is properly aligned with the plotting surface 228 before dispensing the note 220 and/or the envelope 224. In some embodiments, the plotting station may comprise one or more guides 232 that protrude from the plotting surfaces 228 that are used by the computing device 102 to align the note and envelope feeder 212 with the plotting surface 228. In some embodiments, the plotting surface 228 may be adjustable (e.g., the guides 232 may be adjustable relative to the plotting surface 228) such that a size of the plotting surface 228 in the first dimension matches the size of the note 220 or the envelope 224.

In some embodiments, the plotting surface 228 may be positioned at an angle relative to the one or more planes of the coordinate system 202. That is, plotting surface 228 may be slanted or otherwise not parallel to a first plane of the coordinate system 202 (e.g., the XZ-plane). Stated differently, the plotting surface 228 may be perpendicular to none of the planes of the coordinate system 202 (e.g., the XZ-plane, the XY-plane, the YZ-plane). Such orientation of the plotting surface 228 may permit the paper to move off the plotting surface 228 (e.g., slide off the plotting surface 228 due to gravity) without input from the automated plotting system 100. The plotting surface 228 may comprise a plate made from plastic, metal, composite, and/or the like. In one example, a vacuum may be disposed behind the plate with a number of ports running through the plate to a surface where the note 220 is oriented. In this case, after a piece of paper (e.g., the note 220) is dispensed from the note and envelope feeder 212, the vacuum may be activated (e.g., by the computing device 102) to hold the note 220 in place while the plotter pen 236 of the Axidraw pen plotter 132 inscribes a handwritten note on the note 220. Additionally or alternatively, the note 220 may be held in place by one or more grippers, fingers, or clamps that are actuatable (e.g., into a holding state and a released state) by an air cylinder, a solenoid, combinations thereof, and/or the like. In any event, when the automated handwriting is completed, the vacuum may be deactivated and/or the gripper may be released (e.g., by the computing device 102) and the note 220 may be allowed to slide from the plotting surface 228 into the note and envelope bin 216 disposed at a front of the plotting station 200A. In some examples, air may be directed through the ports in the plate of the plotting surface 228 (e.g., via activating a fan, or solenoid valve, configured to output air, etc.) in a direction toward the note 220. This air direction may release the note 220 from being held against the plotting surface 228 and even provide an air cushion that decreases a friction contact between the note 220 and the plotting surface 228. The vacuum and/or the air output device providing the air direction may be accompanied by an anti-static device to eliminate or otherwise decrease static friction between the note 220 and the plotting surface 228. In some embodiments, the plotting surface 228 may include one or more stops (e.g., ledges) that prevent the page dispensed from the note and envelope feeder 212 from initially moving off the plotting surface 228. The stops may be controllable by the computing device 102 such that, once the note 220 and/or the envelope 224 have been written on or otherwise marked, the stops may be disengaged, permitting the note 220 and/or the envelope 224 to slide or otherwise move off the plotting surface 228. The angle that the plotting surface 228 forms with the first plane of the coordinate system 202 is not limited. For instance, the plotting surface 228 may form an angle of between 1 degree and 90 degrees. In one embodiment, the angle may be about 45 degrees.

Each of the plotting stations 200A, 200B may comprise one or more note and envelope bins 216. The note and envelope bins 216 may be, or comprise, one or more three-dimensional (3D) volumes or containers capable of capturing the note 220 and/or the envelope 224 as the note 220 and/or the envelope 224 move off the plotting surface 228. In some embodiments, the note and envelope bins 216 may be sized based on the dimensions of the note 220 and/or the envelope 224. The note and envelope bins 216 may be attached to the frame 204 and/or the plotting surface 228.

Each of the plotting stations 200A, 200B may comprise a Axidraw pen plotter 132. The Axidraw pen plotter 132 may be configured to move in one or more directions (e.g., the X-axis direction, the Y-axis direction, the Z-axis direction) to reach any portion of the note 220 and/or the envelope 224. The Axidraw pen plotter 132 may grip, hold, or otherwise manipulate a plotter pen 236. The plotter pen 236 may be a pen, pencil, marker, highlighter, or any other device capable of applying one or more markings (e.g., applying/distributing ink, applying graphite markings, applying highlights, etc.) to the note 220 and/or the envelope 224. In some embodiments, the Axidraw pen plotter 132 may be controlled by the computing device 102, such that instructions or data processed by the computing device 102 and/or components thereof (e.g., the processor 104) cause the Axidraw pen plotter 132 to move. The Axidraw pen plotter 132 may be moved by one or more motors or other actuation devices (not shown) to position the Axidraw pen plotter 132 in accordance with the processed instructions or data.

The Axidraw pen plotter 132 may comprise a Raspberry Pi controller and graphical interface 240. The Raspberry Pi controller and graphical interface 240 may be communicatively coupled with the Axidraw pen plotter 132 and configured to cause the Axidraw pen plotter 132 to move. The Raspberry Pi controller and graphical interface 240 may wired or wirelessly connected to the Axidraw pen plotter 132, such that the Raspberry Pi controller and graphical interface 240, upon receiving instructions (e.g., instructions to inscribe a first pattern on a document), the Raspberry Pi controller and graphical interface 240 can cause the Axidraw pen plotter 132 to move in such a manner to carry out the inscription of the first pattern.

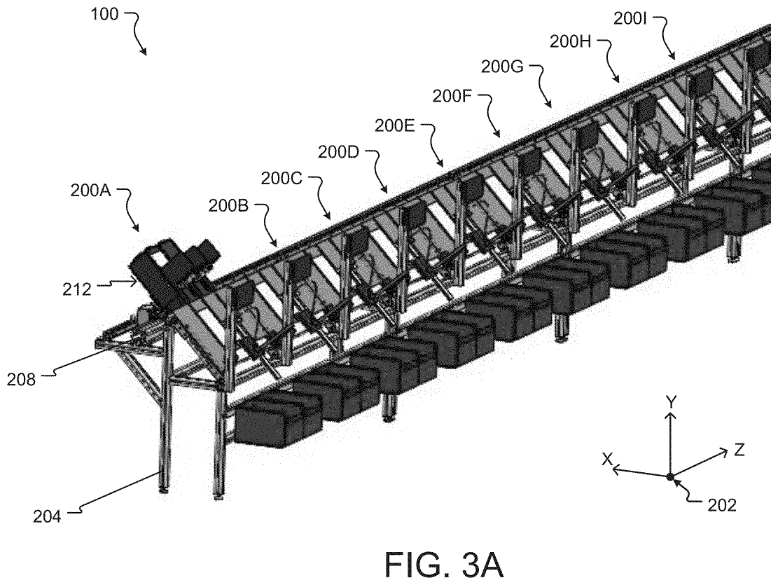

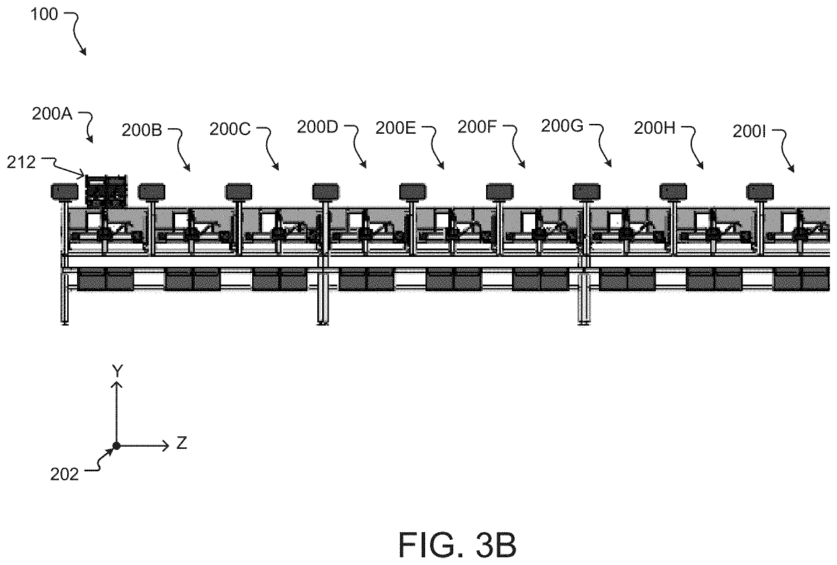

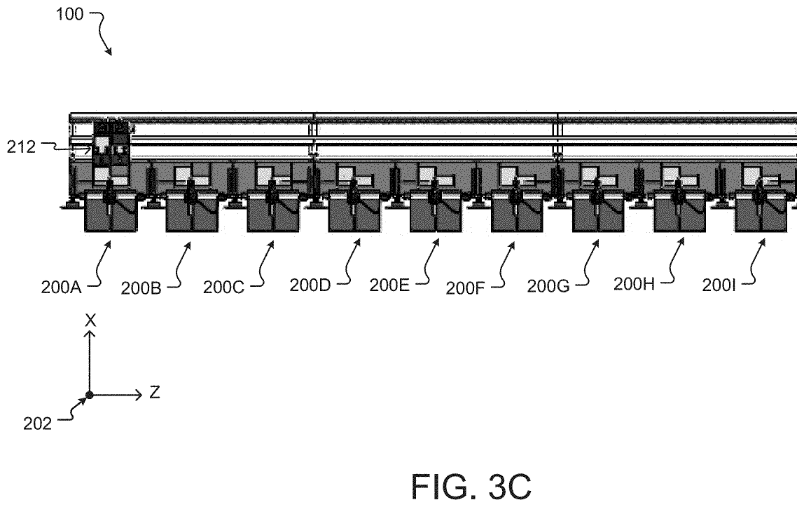

While the above is discussed with respect to plotting stations 200A, 200B, it is to be understood that multiple plotting stations may be operated and/or maintained within the automated plotting system 100. As illustrated in FIGS. 3A-3C, the automated plotting system 100 may comprise additional plotting stations 200C-200I. In some embodiments, each plotting station 200A-200I may operate individually of the other plotting stations 200A-200I (e.g., the inscriptions or movements of a Axidraw pen plotter 132 associated with the plotting station 200A may be different from the inscriptions or movements of the Axidraw pen plotter 132 associated with the plotting station 200B). In other embodiments, one or more of the plotting stations may operate in tandem (e.g., the inscriptions or movements of a Axidraw pen plotter 132 associated with the plotting station 200A may be the same as the inscriptions or movements of the Axidraw pen plotter 132 associated with the plotting station 200B). The note and envelope feeder 212 may be configured to move along each of the plotting stations 200A-200I to dispense papers or other pages.

The note 220 and/or the envelope 224 may be sheets of paper, parchment, or other material capable of receiving and/or retaining markings (e.g., ink markings, graphite markings, etc.). In some embodiments, the note 220 and/or the envelope 224 may have any length and/or width. Non-limiting examples of the page sizes include the ISO 216 standard for paper sizes, such as A0, A1, A2, A3, A4, A5, A6, A7, A8, A9, or A10 sizes; B0, B1, B2, B3, B4, B5, B6, B7, B8, B9, or B10 sizes; or C0, C1, C2, C3, C4, C5, C6, C7, C8, C9, or C10 sizes. For example, the note 220 and/or the envelope 224 may be 26 millimeters (mm) in a first dimension and 37 mm in a second dimension (which may correspond to the A10 format size). Additionally or alternatively, the note 220 and/or the envelope 224 may be dispensed and/or held in a portrait or a landscape orientation.

In some embodiments, the Axidraw pen plotter 132 may be controlled by the computing device 102, which may receive instructions (e.g., from a device 136) to cause the Axidraw pen plotter 132 to move such that a first mark is inscribed on a first surface of the note 220 and/or the envelope 224. The instructions may be based on a template (e.g., a pre-defined user template for a set of words to be inscribed on the note 220 and/or the envelope 224 by the Axidraw pen plotter 132). The received instructions may then be converted into a first set of movements of the Axidraw pen plotter 132. The first set of movements of the Axidraw pen plotter 132 may cause the plotter pen 236 connected to the Axidraw pen plotter 132 to inscribe one or more markings; one or more words; one or more symbols (e.g., trademark symbols, registered trademark symbols); one or more logos, one or more signs (e.g., ampersands, asterisks, at signs, bullets, dollar and/or cent signs, copyright symbols, number signs/pound signs/pound keys/hashes, percent signs, tildes); combinations thereof; and/or the like on the surface of the note 220 and/or the envelope 224. In some embodiments, the template may be or comprise information related to the handwriting of a user, such that the device 136 moves such as a user's hand would move when using the plotter pen 236. In such embodiments, the template may contain personalized handwriting samples of the user's handwriting, such that one or more features of the user's handwriting (e.g., the user's pressure, the user's slant, the user's flow, the user's penmanship, the user's font style such as cursive writing) may be mimicked by the movements of the Axidraw pen plotter 132. In some embodiments, the Axidraw pen plotter 132 and/or the plotter pen 236 may remain fixed, while the surface on which the note 220 and/or the envelope 224 (e.g., the plotting surface 228) moves relative to the Axidraw pen plotter 132 and/or the plotter pen 236. In such embodiments, the instructions may cause the plotting surface 228 to move such that the markings appear on the note 220 and/or the envelope 224 without the Axidraw pen plotter 132 and/or the plotter pen 236 moving. In some examples, the plotting surface 228 may move in two directions along a plane axis, while the Axidraw pen plotter 132 may move in two directions along an arm axis (e.g., that is disposed orthogonal to the plane axis). In this example, the plotting station 200A may generate shapes based on interpolation, single movements, and/or any other compound movements between the Axidraw pen plotter 132 and the plotting surface 228.

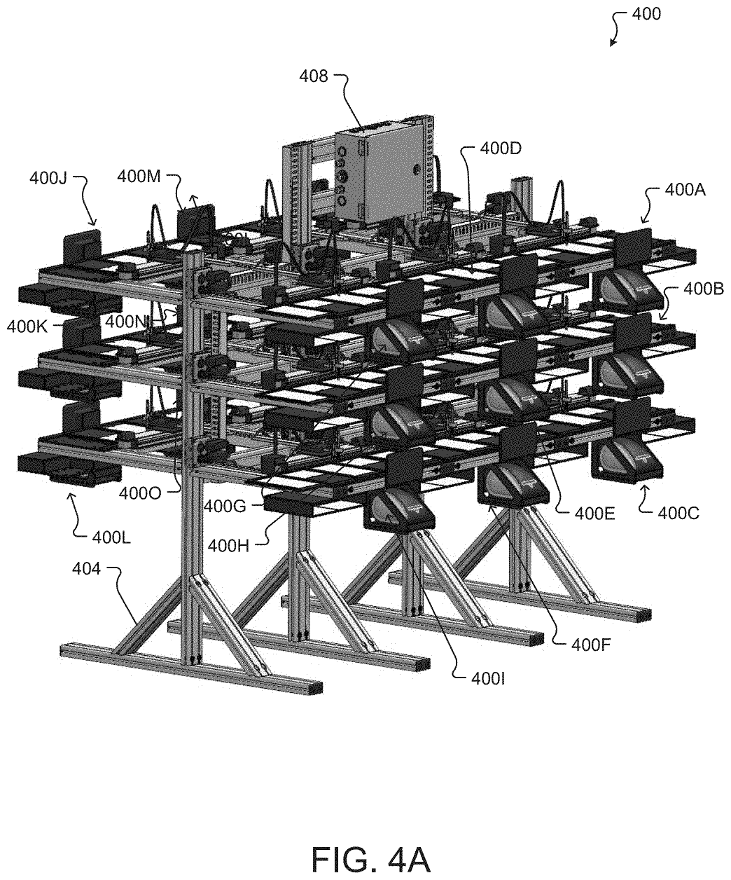

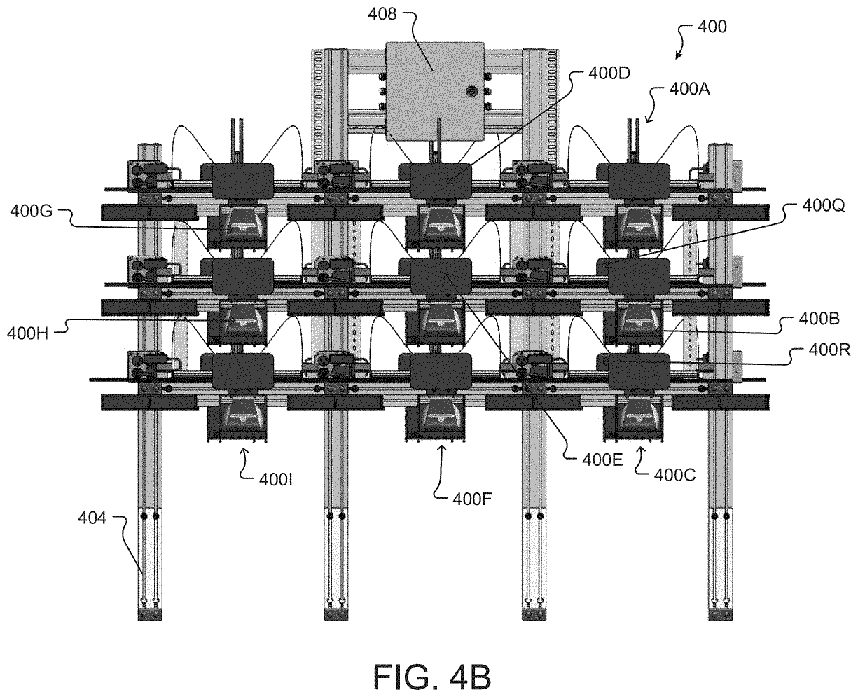

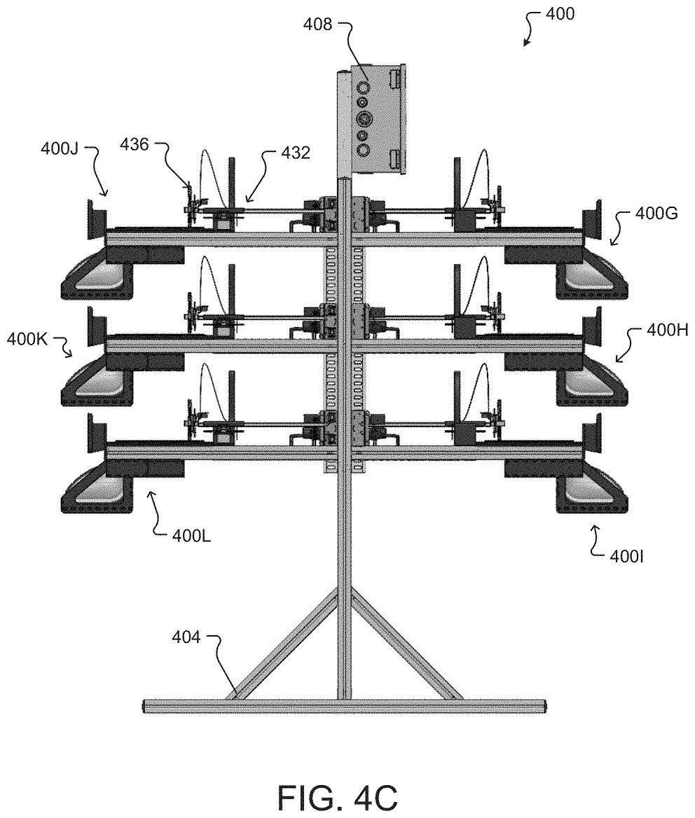

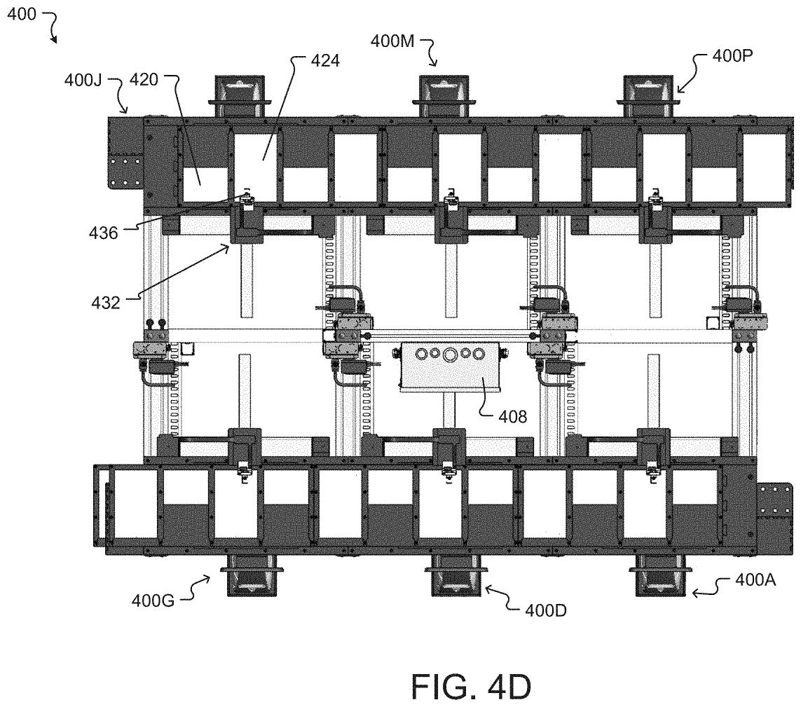

FIGS. 4A-4D illustrate aspects of an automated plotting system 400. The automated plotting system 400 of FIGS. 4A-4D may be similar to or the same as the automated plotting system 100 and/or may have similar components as the system 100 described in conjunction with FIGS. 1-3C. For example, the automated plotting system 400 may comprise a power distribution panel 408, which may be distribute power to one or more plotting stations. In one example, the power distribution panel 408 may correspond to a controller (e.g., a programmable logic controller (PLC), an SLC, etc.). The automated plotting system 400 may comprise a frame 404 that may support other components of the system 400. The frame 404 may correspond to a machine frame (e.g., welded metal frame, extruded aluminum modular framing system, and/or combinations thereof, etc.) The automated plotting system 400 may comprise one or more plotting stations 400A-400R. Each plotting station 400A, 400B, 400C, etc. may comprise an Axidraw pen plotter 432 and a plotter pen 436 attached to, gripped, or otherwise held by the Axidraw pen plotter 432. In some embodiments, the Axidraw pen plotter 432 may be similar to or the same as a Axidraw pen plotter 132 and the plotter pen 436 may be similar to or the same as the plotter pen 236. Each of the plotting stations 400A-400R may include an envelope 420 and/or a note 424 disposed on a surface thereof, such that the plotter pen 436 can be moved across a surface of the envelope 420 and/or the note 424 to create markings thereon.

In some embodiments, a first set of plotting stations 400A-400I may be positioned or arranged on a first side of the automated plotting system 400, while a second set of plotting stations 400J-400R may be positioned or arranged on a second side of the automated plotting system 400. In such embodiments, the plotting stations of the first and second sets may be vertically stacked and/or horizontally arranged relative to the other plotting stations (e.g., to conserve space in an installation site). In at least one embodiment, such as an embodiment shown in FIGS. 4A-4D, the first set of plotting stations 400A-400I and/or the second set of plotting stations 400J-400R may be arranged in 3 by 3 structures (e.g., 3 rows and 3 columns of plotting stations). In other embodiments, additional or alternative plotting stations may be included in the rows and/or columns of the automated plotting system 400 (e.g., 1, 2, 3, 4, 5, 6, 7, 8, 9, 10, or more rows of plotting stations; 1, 2, 3, 4, 5, 6, 7, 8, 9, 10, or more columns of plotting stations; combinations thereof; and/or the like).

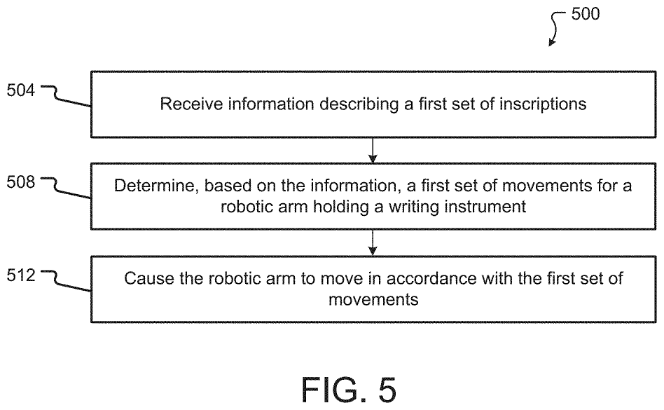

FIG. 5 depicts a method 500 that may be used by the automated plotting system 100, 400, for example, to generate an inscription on a document, parchment, page, sheet of paper, or other material capable of receiving and retaining one or more markings.

The method 500 (and/or one or more steps thereof) may be carried out or otherwise performed, for example, by at least one processor. The at least one processor may be the same as or similar to the processor(s) 104 described above. A processor other than any processor described herein may also be used to execute the method 500. The at least one processor may perform the method 500 by executing instructions and/or other elements stored in a memory such as instructions 120. The elements stored in memory and executed by the processor may cause the processor to execute one or more steps of a function as shown in method 500.

The method 500 comprises receiving information describing a first set of inscriptions (step 504). The first set of inscriptions may be based on user data stored in a memory 106 and/or a database 130. For instance, the user data may include data indicating the slant and pressure the user applies when the user writes with a writing instrument. In some embodiments, the first set of inscriptions may be or comprise words, letter, symbols, marks, signs, combinations thereof, and/or or the like. In some embodiments, the step 504 may include receiving a second set of inscriptions. The second set of inscriptions may comprise words, letters, symbols, marks, signs, combinations thereof, and/or the like, and may be different than the words, letters, symbols, marks, and/or signs of the first set of inscriptions.

The method 500 also comprises determining, based on the information, a first set of movements for a Axidraw pen plotter holding a writing instrument (step 508). The first set of movements may correspond to movements that cause the first set of inscriptions to appear on a surface of a sheet of paper. In other words, the first set of movements may be movements that cause the writing instrument gripped by the Axidraw pen plotter to move across the surface of the sheet of paper to create the first set of inscriptions thereon. In some embodiments, the step 508 may additionally or alternatively comprise determining a second set of movements of a second Axidraw pen plotter holding a second writing instrument. In such embodiments, the second set of movements may be such that the second set of inscriptions is created on a second sheet of paper, such that both the first and second sheet of paper can be inscribed with the first and second set of inscriptions, respectively.

The method 500 also comprises causing the pen plotter to move in accordance with the first set of movements (step 512). The movement of the Axidraw pen plotter may cause the writing instrument to move across the surface of the sheet of paper such that the first set of inscriptions is created on the surface of the sheet of paper. In some embodiments, the step 512 may additionally or alternatively comprise causing a second Axidraw pen plotter to move in accordance with a second set of movements. The second set of movements of the Axidraw pen plotter may cause the second writing instrument to move across a surface of the second sheet of paper to generate the second set of inscriptions on the second sheet of paper. In some embodiments, the first writing instrument and/or the second writing instrument may be similar to or the same as the plotter pen 236, 436

The present disclosure encompasses embodiments of the method 500 that comprise more or fewer steps than those described above, and/or one or more steps that are different than the steps described above.

As noted above, the present disclosure encompasses methods with fewer than all of the steps identified in FIG. 5 (and the corresponding description of the method 500), as well as methods that include additional steps beyond those identified in FIG. 5 (and the corresponding description of the method 500). The present disclosure also encompasses methods that comprise one or more steps from one method described herein, and one or more steps from another method described herein. Any correlation described herein may be or comprise a registration or any other correlation.

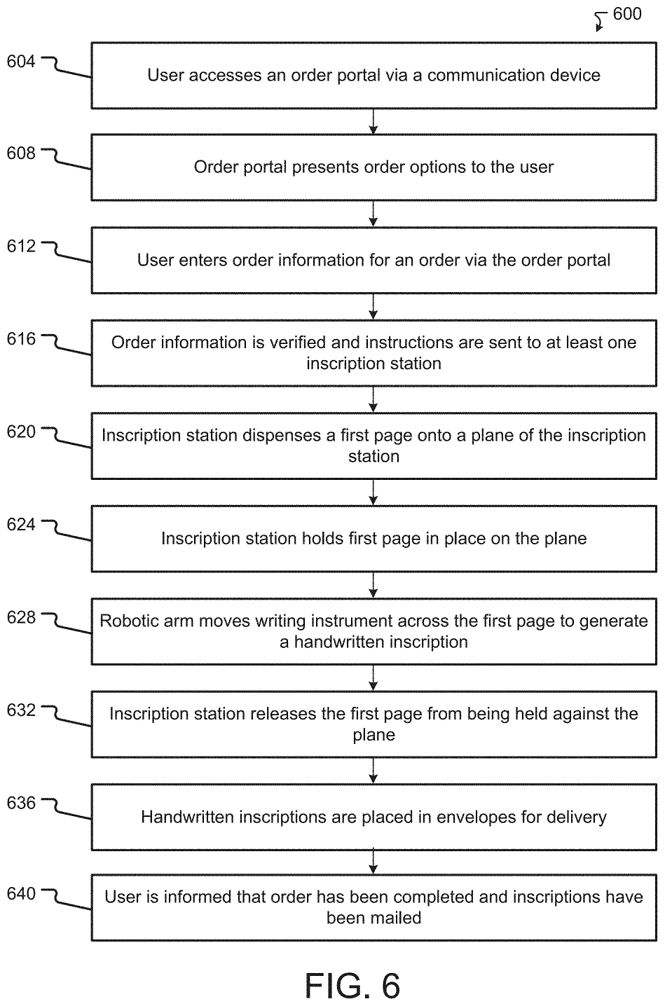

FIG. 6 is a flow diagram of a method 600 for generating automatic realistic handwritten notes by an automated plotting system 100, 400 in accordance with examples of the present disclosure. The method 600 may begin by a user accessing an order portal via a communication device 136 (step 604). In some examples, the user may be required to setup, or enroll in, a user account prior to accessing the order portal. The user account may comprise a credentials (e.g., username, password, etc.), preferences, and/or payment information (e.g., credit card information, pay service account information, etc.). Once the user is enrolled, the user can access the order portal by providing credentials via the communication device.

Next, the method 600 may proceed by the order portal presenting order options to the user (step 608). The order options may include one or more options for generating handwritten notes that can be selected and/or configured by a user. For instance, the options may include standard options such as typical types of notes and formats (e.g., condolence, congratulations, thank you, happy birthday, happy anniversary, get well, and/or the like), types of media (e.g., parchment, plain paper, cardboard, vellum, etc.), handwriting styles (e.g., sloppy, neat, calligraphic, mixed, Spencerian, cursive, block print, and/or the like), marking colors (e.g., pen colors, pencil colors, etc.), marking thicknesses, and/or the like. In some examples, the options may include user-configurable options. For instance, the user may upload handwriting samples that can be analyzed by the computing device 102 in generating mimicked handwriting output via the automated plotting system 100, 400. Additionally or alternatively, the configurable options may include custom textual content that can be entered by the user. In some examples, the configurable options may include “realism” options that allow a user to control the amount of variability in written output for the inscription. Stated another way, the user may intentionally add mistakes, ink spots, missed connections, smudges, thickness variations, and/or other imperfections that add to the realism provided by the automated plotting system 100, 400 when generating the inscriptions. One or more of these realism options may include a slider bar, scroll wheel, and/or percentage amount that is caused to be rendered to the communication device 136 and that can be adjusted by a user prior to placing an order for an inscription. In some examples, the realism may be set to a random number by the computing device 102. In any event, after the realism is set or selected via these options, the communication device 136 may be caused to render a sample of how the realism would affect simulated handwritten text to a window. At this point the user may adjust or accept the settings. It is an aspect of the present disclosure, that the variability may include variations in the textual content of inscriptions (e.g., from one to another) that are provided to more than one recipient. For instance, the automated plotting system 100, 400 may provide different textual content between inscriptions that are sent to recipients at a same company, address, or who are in a same family. The different textual content may alter words, conjunctions, closing phrases, sentences, and/or the like. This alteration may aide in enhancing the realism of the handwritten inscription.

The method 600 may continue by the user entering order information for the order, via the order portal (step 612). Examples of the order information may include, but are in no way limited to, the textual content for the inscription, the number of notes to produce, addressee information, paper types, envelope types, handwriting styles, colors, etc. It is an aspect of the present disclosure that the automated plotting system 100, 400 may generate realistic inscriptions comprising handwriting letters and envelopes as well as prepare the inscriptions for mailing via the postal service or other postal carrier service.

Next, the method 600 may proceed by verifying the order information and sending instructions to at least one plotting station 200A-200I, 400A-400R, for generating the inscriptions requested by the user (step 616). In some examples, the instructions may include determining movements for the Axidraw pen plotter 132, 432 that are based on actual handwriting and not a font or typeface. As can be appreciated, computer typeface has no variability, no imperfections, and is consistent in application and repeatability. On the other hand, actual handwriting is imperfect and is more genuine and realistic when variability in stroke, length, and size are incorporated into the handwriting output. The instant automated plotting system 100, 400 is capable of producing or generating handwriting output that is based on actual handwriting and that includes variability, imperfections, and inconsistencies. Typefaces and traditional printers are incapable of producing these variabilities, imperfections, and inconsistencies. In some examples, the actual handwriting may be based on, or mimic a user's handwriting. By way of example, a user may provide samples of handwriting by reproducing specific words that include letters, numbers, and/or symbols that will be used in the inscription. These samples may be analyzed by the computing device 102 and/or an artificial intelligence handwriting analysis system to generate a handwriting style that includes pseudorandom, or random, variability that is based, at least in part, on the variability of the samples provided. The instructions may include movements for the Axidraw pen plotter 132, 432 (e.g., X-axis, Y-axis, Z-axis, etc.) that defines how the plotter pen 236 contacts the note 220 and/or the envelope 224 to mimic the handwriting style and the variability for the inscriptions.

The method 600 may continue by the automated plotting system 100, 400 dispensing the note 220 onto the plotting surface 228 of a plotting station (step 620). The note and envelope feeder 212 may dispense the note 220 for one or more of the plotting stations 200A-200I, 400A-400R of a respective automated plotting system 100, 400.

Once the note 220 and/or the envelope 224 has been dispensed, the respective plotting stations 200A-200I, 400A-400R may hold the note 220 and/or the envelope 224 in place (step 624). The note 220 and/or the envelope 224 may be held by one or more vacuums, clamps, grippers, and/or fingers. In some examples, the note 220 and/or the envelope 224 may be held against the plotting surface 228 at one or more edges or corners of the paper.

Next, the method 600 proceeds by moving the Axidraw pen plotter 132, 432 and, more specifically, the plotter pen 236 on the note 220 and/or the envelope 224 generating the handwritten inscription (step 628).

When the inscription is complete, the method 600 continues by releasing the note 220 and/or the envelope 224 from being held against the plotting surface 228 (step 632). This release may include activating or deactivating (e.g., via a command issued by the processor 104, etc.) the one or more vacuums, clamps, grippers, and/or fingers. When the note 220 and/or the envelope 224 is released from the clamped state into a released state, the note 220 and/or the envelope 224 may automatically slide, or index, into the note and envelope bin 216.

In some examples, once the inscriptions (e.g., on the notes and/or envelopes) are collected from the note and envelope bins 216, the letters may be placed into the corresponding envelopes for delivery by a mail or postal carrier (step 636). In some examples, the inscriptions may be sent to individual recipients, or addressees, specified by the user (e.g., during the order, etc.). In some cases the addressee may be the user. In one example, the inscriptions may be sent to a regional distribution center for affixing local postage and/or meter stamps before being delivered to a recipient, or addressee. For instance, a user may wish Valentine's Day notes, cards, or letters (e.g., inscriptions) to be sent from Loveland, Colorado and include the Loveland, Colorado meter and stamp. In this case, the automated plotting system 100, 400 may send the inscriptions, in bulk or individually, to a distribution center in Colorado for further processing, where the inscriptions are mailed from Loveland, Colorado. As another example, the user may wish to send letters, postcards, or other correspondence (e.g., inscriptions) from an address that is local to the recipient. In this case, the automated plotting system 100, 400 may send the inscriptions, in bulk or individually, to a distribution center near the local address of the recipient for further processing, where the inscriptions are mailed from that local address.

The method 600 may end by informing the user that their order has been completed and that the inscriptions have been mailed (step 640). This informing may be performed by sending an instant message, text message, email, or notification to the communication device 136 of the user.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
a processor; and
a memory storing data thereon that, when executed by the processor, cause the processor to:
receive a first set of instructions;
determine, based on the first set of instructions, a first set of movements for a pen plotter; and
cause the pen plotter holding a writing instrument to move along a surface of a note based on the first set of instructions.

2. The system of claim 1, wherein the writing instrument is a pen, a pencil, or a marker.

3. The system of claim 1, wherein the writing instrument produces one or more markings on the surface of the note.

4. The system of claim 3, wherein the first set of movements of the pen plotter cause one or more words to appear on the surface of the note.

5. The system of claim 4, wherein the one or more words appear in cursive.

6. The system of claim 5, wherein the first set of movements of the pen plotter mimic a handwriting of a first user.

7. A system, comprising:
a pen plotter coupled with a writing instrument;
a processor; and
a memory storing instructions thereon that, when executed by the processor, cause the processor to:
cause the pen plotter to move along a surface of a sheet of paper.

8. The system of claim 7, wherein the writing instrument distributes ink onto the sheet of paper.

9. The system of claim 8, wherein the distribution of ink causes one or more words to appear on the surface of the sheet of paper.

10. The system of claim 7, wherein the sheet of paper spans at least 26 millimeters (mm) a first dimension and at least 37 mm in a second dimension.

11. A stationery apparatus, comprising:
a processor;
a memory including data stored thereon;
a paper dispenser; and
a plurality of plotting stations,
wherein the plurality of plotting stations includes a first plotting station, the first plotting station comprising:
a first pen plotter mechanically coupled to a first writing instrument;
a first plotting surface configured to receive a first sheet of paper; and
a first paper receptacle, and
wherein the data, when executed by the processor, cause the processor to:
cause the paper dispenser to move to a first end of the first plotting surface of the first plotting station, the paper dispenser configured to distribute the first sheet of paper onto the first plotting surface,
cause the first pen plotter of the first plotting station to move such that the first writing instrument produces a first mark on the first sheet of paper.

12. The stationery apparatus of claim 11, wherein the paper dispenser is mounted to at least one rail such that the paper dispenser is movable from the first plotting surface to a second plotting surface of a second plotting station of the plurality of plotting stations.

13. The stationery apparatus of claim 11, wherein the first plotting surface forms a first angle with a horizontal virtual plane.

14. The stationery apparatus of claim 13, wherein the first angle is between about 1 degree and 50 degrees.

15. The stationery apparatus of claim 14, wherein a first parchment receptacle forms a three-dimensional (3D) volume, and wherein the first sheet of paper is slidable from the first plotting surface into the first parchment receptacle.

16. The stationery apparatus of claim 11, wherein the data further cause the processor to:
cause a second pen plotter to move such that a second writing instrument creates a second mark on a second sheet of paper.

17. The stationery apparatus of claim 16, wherein the first mark is different from the second mark.

18. The stationery apparatus of claim 17, wherein the first mark is a first word, and wherein the second mark is second word.

19. The stationery apparatus of claim 16, wherein the first mark is the same as the second mark.

20. The stationery apparatus of claim 17, wherein the first mark is a first word.
